(19) United States
(12) Patent Application Publication
(10) Pub. No.: US 2009/0216492 A1
(43) Pub. Date: Aug. 27, 2009

(54) Solar radiation shielding member and solar radiation shielding member forming fluid dispersion

(75) Inventors: Takeshi Chonan, Chiba (JP); Kenji Adachi, Chiba (JP)

Correspondence Address: KRATZ, QUINTOS & HANSON, LLP, 1420 K Street, N.W., Suite 400, WASHINGTON, DC, 20005, US

(73) Assignee: SUMITOMO METAL MINING CO., LTD., Tokyo (JP)

(21) Appl. No.: 12/453,034

(22) Filed: Apr. 28, 2009

Related U.S. Application Data
(62) Division of application No. 10/533,586, filed on May 3, 2005.

(30) Foreign Application Priority Data
Jan. 23, 2003 (JP) 014875/2003
Nov. 25, 2003 (JP) 394783/2003

(51) Int. Cl. G06F 15/00

(52) U.S. Cl. 702/182

(57) ABSTRACT

A solar radiation shielding member comprising solar radiation shielding fine particles, which has a transmittance having a maximum value at a wavelength of from 400 nm to 700 nm and a minimum value at a wavelength of from 700 nm to 1,800 nm, and, where the maximum value of the transmittance is represented by P, the minimum value thereof by B and the visible-light transmittance by VLT, has solar radiation shielding performance satisfying the following mathematical expression (1) at 60%≦VLT≦80% or satisfying the following mathematical expression (2) at 38%≦VLT≦55%:

P/B+0.2067×VLT≧17.5 (1); or

P/B+2.4055×VLT≧133.6 (2).

### TECHNICAL FIELD

This invention relates to a solar radiation shielding member such as single-sheet glass, laminated glass, plastics or the like used in window materials for automobiles, buildings, offices, general houses and so forth, and in telephone booths, show windows, illuminating lamps, transparent cases and so forth. More particularly, it relates to a solar radiation shielding member having a stated solar radiation shielding performance, and to a solar radiation shielding member forming fluid dispersion used for forming this member.

### BACKGROUND ART

As methods for removing or mitigating heat components from external light sources such as sunlight and light bulbs, it has conventionally been prevalent to form on the glass surface a film formed of a material capable of reflecting infrared rays, to provide heat radiation reflecting glass. Then, metal oxides such as FeOx, CoOx, CrOx and TiOx and metallic materials such as Ag, Au, Cu, Ni and Al have been selected as materials therefor.

Now, these materials have properties to simultaneously reflect or absorb visible light rays as well, besides infrared rays which contribute greatly to thermal effect. Hence, there has been a problem that they may have a low visible-light transmittance. In particular, in substrates used for construction materials, vehicles, telephone booths and so forth, they are required to have a high transmittance in the visible-light region. Accordingly, their layer thickness have had to be set very small when the above materials such as metal oxides are used. For this reason, a method is employed in which thin films on the level of 10 nm are formed by spray-and-baking or CVD, or by physical film forming processes such sputtering and vacuum deposition.

However, these film forming processes require large-scale apparatus or vacuum equipment, and have difficulties in productivity and large-area film formation, and are disadvantageous in that a high film production cost may result. Also, an attempt to achieve high solar radiation shielding performance by the use of these materials tends to simultaneously result in a high reflectance as well in the visible-light region, and there has also been a disadvantage that a glaring appearance like mirrors may be given to spoil the beauty of products. Moreover, films formed using these materials have had another disadvantage that they have a relatively low resistance to have so high a reflectance to radio waves that the films may reflect radio waves of, e.g., cellular telephones, television sets and radio sets to make them unreceivable or to cause radio wave obstructions in the surrounding areas.

In order to remedy such disadvantages, it has been necessary for such films to be films having, as their physical properties, a low reflectance to light in the visible-light region and a high reflectance in the infrared region, and also a surface resistivity which is controllable to approximately 10⁶ Ω/square or more.

Incidentally, as materials having a high visible-light transmittance and moreover a superior solar radiation shielding function, antimony tin oxide (hereinafter abbreviated “ATO”) and indium tin oxide (hereinafter abbreviated “ITO”) are conventionally known in the art.

These materials have a relatively low visible-light reflectance, and hence by no means give any glaring appearance. However, since plasma frequency is in the near-infrared wavelength region, they have still had an insufficient reflection and absorption effect in a near infrared region close to the visible-light region. In addition, these materials have a low solar radiation shielding power per unit weight, and hence have had a problem that the materials must be used in a large quantity in order to achieve a high shielding function, resulting in a high cost.

### DISCLOSURE OF THE INVENTION

The present invention has been made taking note of such problems, and what it concerns is to provide a new suitability standard required in solar radiation shielding members of this type, and also to provide a solar radiation shielding member that satisfies this standard, and a fluid dispersion used for forming such a solar radiation shielding member (a solar radiation shielding member forming fluid dispersion).

More specifically, the first-aspect invention concerning the solar radiation shielding member is a solar radiation shielding member comprising solar radiation shielding fine particles, wherein;

the solar radiation shielding member has a transmittance having a maximum value at a wavelength of from 400 nm to 700 nm and a minimum value at a wavelength of from 700 nm to 1,800 nm, and, where the maximum value of the transmittance is represented by P, the minimum value thereof by B and the visible-light transmittance by VLT, has solar radiation shielding performance satisfying the following mathematical expression (1) at 60%≦VLT≦80%:

P/B+0.2067×VLT≧17.5 (1).

The second-aspect invention concerning the solar radiation shielding member is a solar radiation shielding member comprising solar radiation shielding fine particles, wherein;

the solar radiation shielding member has a transmittance having a maximum value at a wavelength of from 400 nm to 700 nm and a minimum value at a wavelength of from 700 nm to 1,800 nm, and, where the maximum value of the transmittance is represented by P, the minimum value thereof by B and the visible-light transmittance by VLT, has solar radiation shielding performance satisfying the following mathematical expression (2) at 38%≦VLT≦55%:

P/B+2.4055×VLT≧133.6 (2).

The invention concerning the solar radiation shielding member forming fluid dispersion is a solar radiation shielding member forming fluid dispersion which contains a solvent and solar radiation shielding fine particles dispersed in the solvent and is used for forming the solar radiation shielding member, wherein;

the solar radiation shielding fine particles comprise fine boride particles having an average primary-particle diameter of 400 nm or less and a lattice constant of from 4.100 to 4.160, and having a powder color in the L*a*b* color system of which L* is from 30 to 60, a* is from −5 to 10 and b* is from −10 to 2.

### BRIEF DESCRIPTION OF THE DRAWINGS

FIG. 1 is a graph showing the relationship between VLT and P/B of a solar radiation shielding member produced using a solar radiation shielding member forming fluid dispersion serving as a standard.

FIG. 2 is a graph showing a transmission profile of a solar radiation shielding member according to Example 1.

### BEST MODES FOR PRACTICING THE INVENTION

To describe the present invention in greater detail, it is described with reference to the accompanying drawings.

At the outset, the solar radiation shielding member according to the present invention is characterized in that, as summarized above, it has a transmittance having a maximum value at a wavelength of from 400 nm to 700 nm and a minimum value at a wavelength of from 700 nm to 1,800 nm, and, where the maximum value of the transmittance is represented by P, the minimum value thereof by B and the visible-light transmittance by VLT, has solar radiation shielding performance satisfying the following mathematical expression (1) at 60%≦VLT≦80% or satisfying the following mathematical expression (2) at 38%≦VLT≦55%.

P/B+0.2067×VLT≧17.5 (1)

P/B+2.4055×VLT≧133.6 (2)

Here, the visible-light transmittance VLT is the value calculated on the basis of a visible-light transmittance calculation method (JIS A 5759). Stated specifically, it is the value found by measuring with a spectrophotometer the spectral transmittance τ(λ) of each wavelength at intervals of 10 nm in the wavelength range of from 380 nm to 780 nm and making calculation according to the following mathematical expression (3).

$$τ v = {\sum }_{380}^{780} {D}_{λ} τ ( λ ) {V}_{λ} λ / {\sum }_{380}^{780} {D}_{λ} {V}_{λ} λ \qquad ( 3 )$$

Here, τv is the visible-light transmittance VLT, D_{λ} is the value of spectral distribution at CIE daylight D₆₅ (see the attached table of JIS A 5759), V_{λ} is the CIE light adaptation spectral luminous efficiency, and τ(λ) is the spectral transmittance. Incidentally, CIE is the abbreviation for Commission Internationale de l'Eclairage, Paris.

The above mathematical expressions (1) and (2) are obtainable in the following way: Using a solar radiation shielding member forming fluid dispersion serving as a standard (the fluid dispersion being chiefly composed of fine boride particles, a resin binder or an inorganic binder, and an organic solvent), a solar radiation shielding member the solar radiation shielding performance of which shows a passing standard is made up which is constituted of, e.g., a transparent glass plate of 3 mm thick or a transparent PET film of 50 μm thick and a coating film of 10 μm or less in layer thickness, formed using the solar radiation shielding member forming fluid dispersion. From a transmission profile of this solar radiation shielding member, measured with a spectrophotometer, the maximum value P of transmittance and the minimum value B of transmittance are found to determine the ratio of (maximum value P/minimum value B), and this value (P/B) is plotted with respect to the visible-light transmittance (VLT). In the same way as the above, a plurality of solar radiation shielding members the coating films of which have been made different in layer thickness (i.e., the VLT differs with changes in layer thickness) and the solar radiation shielding performance of which shows the passing standard are repeatedly produced, and their transmission profiles are measured. What have been plotted therefrom are straight-line approximated to draw straight lines, from which the expressions (1) and (2) are obtained. Incidentally, as the binder for the above coating film of 10 μm or less in layer thickness, an ultraviolet-curable resin or a silicate type binder may be used. The binder is not particularly limited thereto as long as it is transparent in the visible-light region.

As to the ratio (P/B) of maximum value to minimum value of the coating film transmittance in the solar radiation shielding member, the solar radiation shielding performance is better as this value is larger. This is evident when it is taken into consideration that the fine boride particles have a transmittance profile in which their transmittance has a maximum value in the wavelengths of from 400 nm to 700 nm and a minimum value in the wavelengths of from 700 nm to 1,800 nm, the visible-light wavelength region is in the form of a hanging bell of from 380 nm to 780 nm and the luminosity factor (visible sensitivity) has its peak at about 550 nm. That is, from these transmission characteristics, it is understood that the fine boride particles transmit visible light effectively, and reflect and absorb heat radiations other than that effectively.

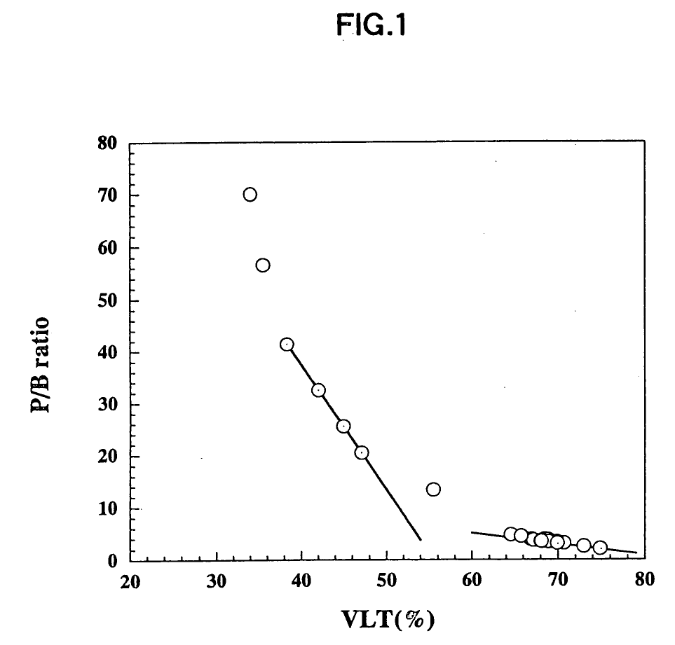

For example, using a solar radiation shielding member forming fluid dispersion serving as a standard which fluid dispersion is chiefly composed of fine LaB₆ particles having an average primary-particle diameter of 250 nm and a dispersed-particle diameter of 600 nm, an ultraviolet-curable resin and a mixed solvent of cyclopentanone and toluene, the above plurality of solar radiation shielding members having different visible-light transmittance (VLT) and also having solar radiation shielding performance showing the passing standard one another are produced. At the same time, the values of P/B are each found from the solar radiation shielding members produced, and are plotted with the VLT as abscissa and the P/B as ordinate. According to the results of such an experiment, the ratios (P/B) of maximum value to minimum value of the transmittance in the solar radiation shielding members having solar radiation shielding performance showing the passing standard have a tendency to change parabolically with the values of visible-light transmittance (VLT) as shown by circles in FIG. 1. However, these can be straight-line (mathematical expression 1) approximated for those of 60%≦VLT≦80% which are within the range of interest as solar radiation shielding members. These can also be straight-line (mathematical expression 2) approximated for those of 38%≦VLT≦55% which are likewise within the range of interest as solar radiation shielding members.

The ratio (P/B) of maximum value to minimum value of the transmittance in the solar radiation shielding member having solar radiation shielding performance showing the passing standard as having been conformed by the above experiment lies on the straight line represented by the equality sign part in the mathematical expression (1) or (2). Hence, what is shown is that the solar radiation shielding member has sufficient solar radiation shielding performance when the ratio (P/B) of maximum value to minimum value of the transmittance in the solar radiation shielding member is equal to, or larger than, the value represented by the equality sign part in the mathematical expression (1) or (2). That is, in order for the solar radiation shielding member to have good solar radiation shielding performance, it is necessary to satisfy the mathematical expression (1) or (2).

As to the solar radiation shielding fine particles used in the present invention, they may comprise fine boride particles having an average primary-particle diameter of 400 nm or less and a lattice constant of from 4.100 to 4.160, and having a powder color in the L*a*b* color system of which L* is from 30 to 60, a* is from −5 to 10 and b* is from −10 to 2. Also, the fine boride particles may include fine hexaboride particles represented by XB₆ (wherein X is at least one selected from the group consisting of Y, La, Ce, Pr, Nd, Sm, Eu, Gd, Tb, Dy, Ho, Er, Tm, Yb, Lu, Zr, Ba, Sr and Ca).

Herein, the average primary-particle diameter is the value calculated in the following way: In, e.g., a paint shaker holding solar radiation shielding particles such as boride particles, a dispersing agent and beads or the like in a solvent, the boride particles are subjected to pulverization and dispersion treatment. After the treatment, the solvent is evaporated off and the dispersing agent is removed by thermal decomposition. Thereafter, the specific surface area (the N₂ adsorption method or the like) of the boride particles is measured, and the value is calculated from the measurements according to the following expression.

d=6/ρ×SA

(wherein d is the average primary-particle diameter, ρ is the boride density, and SA is the specific surface area).

The fine boride particles may be produced by, e.g., a solid-phase reaction process or an evaporation quenching process, or a vapor phase process such as plasma-assisted CVD.

Incidentally, the solid-phase reaction process is described as an example. The production process is by no means limited thereto as long as it can provide the above powder characteristics.

A process for producing LaB₆ (lanthanum boride) by the solid-phase reaction process is described below. First, a reducing agent is added to a boron compound and a lanthanum compound, and these are allowed to react at a high temperature to form lanthanum boride. However, coarse powder having an average primary-particle diameter of 400 nm or more may come formed to attain no desired optical characteristics. Accordingly, in order to control particle size distribution, the product is pulverized by, e,g., a mechanical method such as jet milling or bead milling in a post step, or a particle growth controller is added to prepare the product. Such a method makes it possible to obtain fine lanthanum boride particles having an average primary-particle diameter of 400 nm or less.

The fine boride particles to be used are also those having a powder color in the L*a*b* color system (JIS Z 8729) of which L*, a* and b* are within the ranges of from 30 to 60, from −5 to 10 and from −10 to 2, respectively; the color system being recommended by Commission Internationale de l'Eclairage (CIE). Incidentally, the fine boride particles to be used in the solar radiation shielding member may preferably be not oxidized on their surfaces, but those usually obtainable stand slightly oxidized in many cases and also it is unavoidable to a certain extent that the surface oxidation takes place in the step of dispersing fine particles. Even in such a case, however, there is no change in the effectiveness of exhibiting a solar radiation shielding effect. It, however, is also a fact that the shielding effect may greatly lower if the degree of this oxidation exceeds a certain limit. It is considered that the range of characteristics of the powder color is concerned with the extent of surface oxidation of the particles.

To give the fine hexaboride particles (XB₆) as an example, a larger solar radiation shielding effect is obtained as they have a higher perfectness as crystals. However, even those having so low a crystallizability as to give a very broad diffraction peak in X-ray diffraction can materialize the desired solar radiation shielding effect as long as their basic combinations in the interiors of fine particles are set up with the combinations of X and B, their average primary-particle diameter is 400 nm or less, their lattice constant is from 4.100 to 4.160 and also the powder color's L*, a* and b* are within the ranges of from 30 to 60, from −5 to 10 and from −10 to 2, respectively.

The above solar radiation shielding member may be produced by coating the surface of an appropriate transparent substrate with a solar radiation shielding member forming fluid dispersion containing a solvent and the solar radiation shielding fine particles such as fine boride particles dispersed in the solvent, or by incorporating the solar radiation shielding member forming fluid dispersion into a sheet, a film or the like.

Then, a solar radiation shielding member forming fluid dispersion in which the fine boride particles dispersed in the solvent have been sufficiently finely and uniformly dispersed to have a dispersed-particle diameter of 800 nm or less may be used, whereby the solar radiation shielding member can be obtained which satisfies the requirement of the mathematical expression (1) or (2).

Herein, the dispersed-particle diameter is meant to be agglomerated-particle diameter of the fine boride particles in the solvent, and may be measured with every king of commercially available particle size distribution meter. For example, a fluid dispersion in which the fine boride particles have been dispersed in a solvent in the state that agglomerates of the fine boride particles are also present may be sampled to make measurement with ELS-800, manufactured by Ohtsuka Electronics Co., Ltd., which bases its principle on dynamic light scattering. Then, the fine boride particles may preferably have a dispersed-particle diameter of 800 nm or less. If they have a large dispersed-particle diameter of more than 800 nm, it is difficult to satisfy the requirement of the mathematical expression (1) or (2), resulting, in some cases, in a grayish film or shaped form (plate, sheet or the like) with monotonously lowered transmittance. Also, if agglomerated coarse particles are contained in a large quantity, such particles may serve as a light scattering source to provide a large fog (haze) when made into a film or a shaped form (plate, sheet or the like), and this may cause a decrease in visible-light transmittance, undesirably. Incidentally, the fine boride particles may be dispersed in the solvent by any means without any particular limitations as long as it is a means by which they can uniformly be dispersed in a fluid dispersion. For example, it may include a bead mill, a ball mill, a sand mill, a paint shaker and an ultrasonic homogenizer. Under conditions for dispersion treatment making use of any of these instruments, boride particles are dispersed in the solvent and at the same time continue to be made into fine particles in virtue of the collision and so forth of boride particles against one another, so that the boride particles can be made into finer particles and be dispersed (i.e., treated to become pulverized and dispersed).

The solar radiation shielding member forming fluid dispersion is one in which the fine boride particles have been dispersed in a solvent as described above, on which solvent there are no particular limitations. It may appropriately be selected in conformity with coating conditions and coating environment, and with a binder where an inorganic binder or a resin binder is to be contained. For example, usable are water, and various kinds of organic solvents including alcohols such as ethanol, propanol, butanol, isopropyl alcohol, isobutyl alcohol and diacetone alcohol, ethers such as methyl ether, ethyl ether and propyl ether, esters, and ketones such as acetone, methyl ethyl ketone, diethyl ketone, cyclohexanone and isobutyl ketone. An acid or an alkali may also optionally be added to make pH adjustment. Further, in order to more improve the dispersion stability of fine particles in the fluid dispersion, every kind of surface-active agent, coupling agent and so forth may also be added of course.

In the case when the binder is to be mixed, there are also no particular limitations on the types of the inorganic binder or resin binder. For example, the inorganic binder may include metal alkoxides of silicon, zirconium, titanium or aluminum, and partially hydrolyzed condensation polymers of these, or organosilazanes. Also, as the resin binder, usable are thermoplastic resins such as acrylic resins, thermosetting resins such as epoxy resins, as well as ultraviolet-curable resins and so forth.

At the time the coating film has been formed on a transparent substrate by the use of the solar radiation shielding member forming fluid dispersion, the conductivity of the coating film is gained along conducting paths having passed through areas with which the fine boride particles have come into contact. Hence, the conducting paths can partially be cut by, e.g., adjusting the quantity of the surface-active agent or coupling agent. It is easy to make the coating film have a surface resistivity of 106 Ω/square or more to lower its conductivity. The conductivity may also be controlled by adjusting the quantity of the inorganic binder or resin binder.

For the purpose of improving film strength, the solar radiation shielding member forming fluid dispersion may also contain at least one compound selected from ZrO₂, TiO₂, Si₃N₄, SiC, SiO₂, Al₂O₃ and Y₂O₃. Incidentally, the compound selected from ZrO₂, TiO₂, Si₃N₄, SiC, SiO₂, Al₂O₃ and Y₂O₃ may preferably be in such a content that the value of (weight of the above compound/weight of the fine boride particles)×100 is set within the range of from 0.1% to 250%. This is because, if this value is less than 0.1%, the addition of the compound may be of no effect, and, if it is more than 250%, the proportion of the fine boride particles is so small as to lower their solar radiation shielding function and hence the fluid dispersion may have a low performance.

As described previously, the solar radiation shielding member of the present invention may be produced by coating the surface of an appropriate transparent substrate with the solar radiation shielding member forming fluid dispersion, or by incorporating the solar radiation shielding member forming fluid dispersion into a sheet, a film or the like. Then, where the solar radiation shielding member is constituted of the transparent substrate and the coating film formed thereon, the resin binder or inorganic binder contained in the solar radiation shielding member forming fluid dispersion has the effect of improving adherence of the fine boride particles to the substrate after coating and curing, and further improving the hardness of the film. Also, the coating film thus obtained may further be covered thereon with a coating film as a second layer, composed of a metal alkoxide of silicon, zirconium, titanium or aluminum or a partially hydrolyzed condensation polymer of any of these, to form an oxide film of silicon, zirconium, titanium or aluminum. This enables more improvement in binding force to substrate, film hardness and weatherability of the coating film composed chiefly of the fine boride particles.

A coating film obtained where the resin binder or the inorganic binder is not contained in the solar radiation shielding member forming fluid dispersion has a film structure wherein only the fine boride particles are deposited on the substrate. Then, although such a coating film shows a solar radiation shielding effect even as it is, the surface of this film may further be coated with a coating liquid containing an inorganic binder such as a metal alkoxide of silicon, zirconium, titanium or aluminum or a partially hydrolyzed condensation polymer of any of these, or containing a resin binder, to form a second coating film to provide a multi-layer film. In virtue of such measures, the second film is formed in the state the above coating-liquid component fills up any gaps present between the fine boride particles deposited, of the first-layer. Hence, the film can have a lower haze, its visible-light transmittance is improved, and also the binding of the fine particles to the substrate is improved.

As to coating methods used when the surface of an appropriate transparent substrate is coated with the solar radiation shielding member forming fluid dispersion to form the coating film, there are no particular limitations thereon. Any method may be used as long as it is a method by which the fluid dispersion can evenly and thinly uniformly be coated, as exemplified by spin coating, bar coating, spray coating, dip coating, screen printing, roll coating or cast coating. Also, the substrate which has been coated with the fluid dispersion containing as the inorganic binder a metal alkoxide of silicon, zirconium, titanium or aluminum or a hydrolyzed condensation polymer of any of these may preferably be heated at a temperature of 100° C. or more because, if it is heated to less than 100° C., the alkoxide, or the hydrolyzed condensation polymer thereof, contained in the coating film may often remain there because of incomplete polymerization reaction, and also the water or the organic solvent may remain in the film, to cause a decrease in visible-light transmittance of the film having been heated. The substrate may more preferably be heated at a temperature not lower than the boiling point of the solvent contained in the fluid dispersion. Also, where the resin binder is used, it may be cured in accordance with its corresponding curing method. For example, in the case of an ultraviolet-curable resin, it may appropriately be irradiated with ultraviolet rays. Also, in the case of a cold-curable resin, it may be left as it is, after coating. Accordingly, it is possible for the fluid dispersion to be coated on existing window glass or the like on site.

In the solar radiation shielding member according to the present invention, which is constituted of, e.g., the transparent substrate and the coating film formed thereon, the fine boride particles stand dispersed appropriately in the coating film. Hence, the coating film can be made to avoid taking on glaring appearance, because it is less reflective in the visible-light region than any thin oxide films formed by a physical film forming method which have specular surfaces; the films being densely filled with crystals in their interiors. On the other hand, since plasma frequency is in the wavelength region of from visible light to near infrared, the plasma reflection incidental thereto comes large in the near infrared region. Also, where the reflection in the visible-light region should be further restrained, a film having a low refractive index, such as an SiO₂ or MgF₂ film, may be formed on the coating film in which the fine boride particles stand dispersed, whereby a multi-layer film having a luminous reflectance of 1% or less can be obtained with ease.

In order to further impart ultraviolet radiation shielding function to the solar radiation shielding member according to the present invention, inorganic-type particles of titanium oxide, zinc oxide or cerium oxide or organic-type ones of benzophenone or benzotriazole may also be added alone or in combination of two or more. Also, in order to improve transmittance, particles of ATO, ITO or aluminum-added zinc oxide may further be mixed. These transparent particles increase transmittance at around 750 nm as it is added in a larger quantity, and shield near infrared radiations. Hence, a solar radiation shielding member is obtainable which has a high visible-light transmittance and also higher solar radiation shielding performance. The solar radiation shielding member forming fluid dispersion according to the present invention may also be added to a fluid dispersion in which the particles of ATO, ITO or aluminum-added zinc oxide have been dispersed, whereby the film is colored because the film color of, e.g., the LaB₆ (lanthanum boride) is green, and at the same time its solar radiation shielding effect can be assisted. In this case, the solar radiation shielding effect can be assisted by the addition of the lanthanum boride in a very small quantity with respect to the chief constituent ATO or ITO, and the necessary quantity for ATO or ITO can vastly be reduced to lower the cost for the fluid dispersion.

The solar radiation shielding member forming fluid dispersion according to the present invention can also form a solar radiation shielding member with stable performance, because it is not a fluid dispersion that forms any intended solar radiation shielding member by utilizing decomposition or chemical reaction of components in a liquid by the action of heat at the time of baking.

In addition, the fine boride particles that bring out the solar radiation shielding effect are an inorganic material, and hence have better weatherability than organic materials. For example, the deterioration of color or various functions may little occur even when used at portions exposed to sunlight (ultraviolet radiation).

The present invention is described below in greater detail by giving Examples. Note, however, that the present invention is by no means limited to the following Examples.

As to the powder colors (standard light source: D₆₅, visual field of 10°) of fine particles a to j used in Examples and Comparative Examples and the optical characteristics of solar radiation shielding members A to T obtained using fluid dispersions in which the respective fine particles stand dispersed, they were measured with a spectrophotometer U-4000, manufactured by Hitachi Ltd.

As to solar radiation shielding performance, the maximum value P and minimum value B of transmittance and the visible-light transmittance VLT were determined from the transmission profile of each solar radiation shielding member, and also, from the respective numerical values obtained, the solar radiation shielding performance was found as the value of a left-hand side member of the mathematical expression (1): P/B+0.2067×VLT≧17.5 or the mathematical expression (2): P/B+2.4055×VLT≧133.6, set out previously.

Incidentally, the VLT of each example is controlled by the layer thickness of coating films or the concentration of fillers.

### Example 1

40% by weight of LaB₆ particles of about 2 μm in average particle diameter, 12% by weight of a high-molecular weight type dispersing agent and 48% by weight of isopropyl alcohol were subjected to pulverization and dispersion treatment for 24 hours by means of a paint shaker in which ZrO₂ beads of 0.3 mm in diameter were held, to prepare a LaB₆ fluid dispersion (fluid A). Incidentally, as a result of this pulverization and dispersion treatment, the LaB₆ particles came to have an average primary-particle diameter of 35 nm as shown in Table 1 below.

Next, the quantity of the LaB₆ particles in the LaB₆ fluid dispersion was so adjusted as to be 8 g. This fluid dispersion, 12 g of an ultraviolet-curable resin and 22 g of a mixed solvent of cyclopentanone and toluene were well mixed and stirred to prepare a solar radiation shielding member forming fluid dispersion (fluid B). Here, the LaB₆ particles in the solar radiation shielding member forming fluid dispersion (fluid B) had a dispersed-particle diameter of 83 nm as shown in Table 1.

Incidentally, the numerical values for “Powder color” and “Lattice constant” shown in Table 1 are those found by measuring the fine particles a obtained where the solvent of the fluid A has been removed.

Next, using a bar coater of Bar No. 8 (JIS K 5400), a PET (polyethylene terephthalate) film of 50 μm thick was coated thereon with the solar radiation shielding member forming fluid dispersion (fluid B), followed by irradiation with light of a high-pressure mercury lamp under conditions of 70° C. for 1 minute to obtain solar radiation shielding member A according to Example 1.

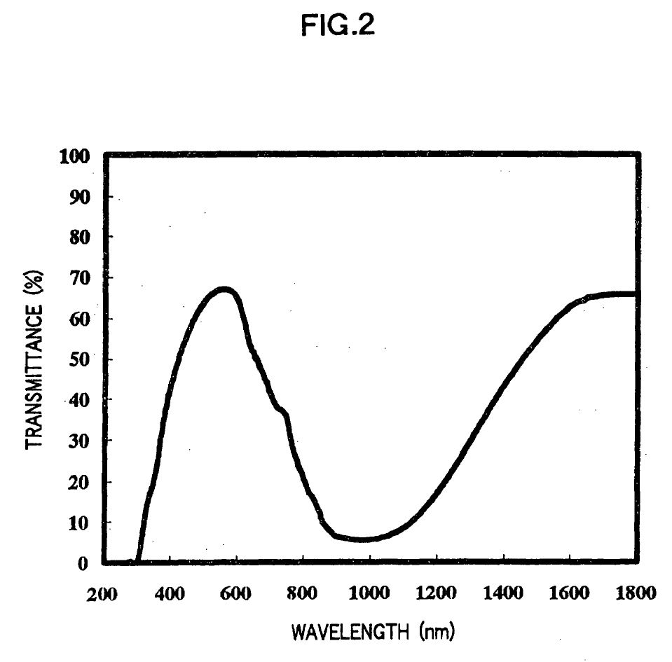

The transmission profile of the solar radiation shielding member A obtained is shown in FIG. 2.

Then, the respective numerical values of i) the maximum value P and minimum value B of transmittance which were determined from this transmission profile and ii) the visible-light transmittance VLT calculated according to the visible-light transmittance calculation method (JIS A 5759) described previously were substituted for the mathematical expression (1) to calculate the solar radiation shielding performance. As the result, it was found to be 24.6% as shown in Table 1.

Thus, it was confirmed that, in the solar radiation shielding member A according to Example 1, its solar radiation shielding performance satisfied the passing standard.

### Example 2

Solar radiation shielding member B according to Example 2 was obtained in the same manner as in Example 1 except that, in place of the ZrO₂ beads, Si₃N₄ beads were used. Its solar radiation shielding performance is also shown in Table 1.

### Example 3

Solar radiation shielding member C according to Example 3 was obtained in the same manner as in Example 1 except that, in place of the ZrO₂ beads, SiC beads were used. Its solar radiation shielding performance is also shown in Table 1.

### Example 4

Solar radiation shielding member D according to Example 4 was obtained in the same manner as in Example 1 except that, in place of the ZrO₂ beads, SiO₂ beads were used. Its solar radiation shielding performance is also shown in Table 1.

### Example 5

Solar radiation shielding member E according to Example 5 was obtained in the same manner as in Example 1 except that, in place of the ZrO₂ beads, Al₂O₃ beads were used. Its solar radiation shielding performance is also shown in Table 1.

### Example 6

Solar radiation shielding member F according to Example 6 was obtained in the same manner as in Example 1 except that, in place of the ZrO₂ beads, Y₂O₃ beads were used. Its solar radiation shielding performance is also shown in Table 1.

### Example 7

Solar radiation shielding member G according to Example 7 was obtained in the same manner as in Example 1 except that, in place of the ZrO₂ beads, TiO₂ beads were used. Its solar radiation shielding performance is also shown in Table 1.

### Example 8

Solar radiation shielding member H according to Example 8 was obtained in the same manner as in Example 1 except that, in place of the fine LaB₆ particles, fine CeB₆ particles were used. Its solar radiation shielding performance is also shown in Table 1.

### Example 9

Solar radiation shielding member I according to Example 9 was obtained in the same manner as in Example 1 except that, in place of the fine LaB₆ particles, fine NdB₆ particles were used. Its solar radiation shielding performance is also shown in Table 1.

### Comparative Example 1

Solar radiation shielding member J according to Comparative Example 1 was obtained in the same manner as in Example 1 except that LaB₆ particles of 15 μm in average particle diameter were used and had an average primary-particle diameter after pulverization and dispersion treatment, of 353 nm (see Table 1) and that the fine LaB₆ particles in the solar radiation shielding member forming fluid dispersion had a dispersed-particle diameter of 910 nm. Its solar radiation shielding performance is also shown in Table 1.

### Example 10

Solar radiation shielding member K according to Example 10 was obtained in the same manner as in Example 1 except that, in preparing the fluid B in Example 1, the quantity of the LaB₆ particles in the LaB₆ fluid dispersion was so adjusted as to be 8.8 g, and a bar coater of Bar No. 40 (JIS K 5400) was used.

Its solar radiation shielding performance found from the mathematical expression (2) is shown in Table 1.

### Example 11

Solar radiation shielding member L according to Example 11 was obtained in the same manner as in Example 10 except that, in place of the ZrO₂ beads, Si₃N₄ beads were used. Its solar radiation shielding performance found from the mathematical expression (2) is also shown in Table 1.

### Example 12

Solar radiation shielding member M according to Example 12 was obtained in the same manner as in Example 10 except that, in place of the ZrO₂ beads, SiC beads were used. Its solar radiation shielding performance found from the mathematical expression (2) is also shown in Table 1.

### Example 13

Solar radiation shielding member N according to Example 13 was obtained in the same manner as in Example 10 except that, in place of the ZrO₂ beads, SiO₂ beads were used. Its solar radiation shielding performance found from the mathematical expression (2) is also shown in Table 1.

### Example 14

Solar radiation shielding member 0 according to Example 13 was obtained in the same manner as in Example 10 except that, in place of the ZrO₂ beads, Al₂O₃ beads were used. Its solar radiation shielding performance found from the mathematical expression (2) is also shown in Table 1.

### Example 15

Solar radiation shielding member P according to Example 15 was obtained in the same manner as in Example 10 except that, in place of the ZrO₂ beads, Y₂O₃ beads were used. Its solar radiation shielding performance found from the mathematical expression (2) is also shown in Table 1.

### Example 16

Solar radiation shielding member Q according to Example 16 was obtained in the same manner as in Example 10 except that, in place of the ZrO₂ beads, TiO₂ beads were used. Its solar radiation shielding performance found from the mathematical expression (2) is also shown in Table 1.

### Example 17

Solar radiation shielding member R according to Example 17 was obtained in the same manner as in Example 10 except that, in place of the fine LaB₆ particles, fine CeB₆ particles were used. Its solar radiation shielding performance found from the mathematical expression (2) is also shown in Table 1.

### Example 18

Solar radiation shielding member S according to Example 18 was obtained in the same manner as in Example 10 except that, in place of the fine LaB₆ particles, fine NdB₆ particles were used. Its solar radiation shielding performance found from the mathematical expression (2) is also shown in Table 1.

### Comparative Example 2

Solar radiation shielding member T according to Comparative Example 2 was obtained in the same manner as in Example 10 except that a fluid dispersion was used in which the fine LaB₆ particles had a dispersed-particle diameter of 910 nm like Comparative Example 1. Its solar radiation shielding performance found from the mathematical expression (2) is also shown in Table 1.

—Evaluation—

As can bee seen from the numerical values of solar radiation shielding performance as shown in Table 1 below, the values of solar radiation shielding performance of the solar radiation shielding member according to each Example, except Comparative Examples 1 and 2, are all “17.5%” (VLT=65%) or more or “133.6%” (VLT=50%) or more. Thus, the superiority of the solar radiation shielding members according to Examples has been confirmed.

Incidentally, the reason why the solar radiation shielding performance of the solar radiation shielding member according to Comparative Example 1 is “−14.6%”, which is less than “17.5%”, and the solar radiation shielding performance of the solar radiation shielding member according to Comparative Example 2 is “122.2%”, which is less than “133.6%”; is that the fine LaB₆ particles in the solar radiation shielding member forming fluid dispersion have a dispersed-particle diameter of more than 800 nm.

TABLE 1

| | | | | | | | | Component | | | |
|---|---|---|---|---|---|---|---|---|---|---|---|
| | | | | | | | | other than | | | |
| | | | | | | Av. | | hexaboride | | | Solar* |
| | | | | | | primary = | Dispersed = | in fluid | | Solar | radiation |
| | | | | | Lattice | particle | particle | dispersion | | radiation | shielding |
| | Fine | Powder color | | | constant | diam. | diam. | & content | | shielding | Performance |
| | particles | L* | a* | b* | (Å) | (nm) | (nm) | | (%) | member | (%) |
| Example: | | | | | | | | | | | |
| 1 | a | 33.8959 | 2.5195 | −6.9554 | 4.1560 | 35 | 83 | ZrO₂ | 140 | A | 24.6 |
| 2 | b | 35.9237 | 2.4115 | −6.8733 | 4.1560 | 35 | 83 | Si₃N₄ | 150 | B | 24.4 |
| 3 | c | 39.7682 | 1.8995 | −6.1967 | 4.1560 | 35 | 83 | SiC | 145 | C | 24.4 |
| 4 | d | 36.6432 | 1.2012 | −4.8880 | 4.1560 | 35 | 83 | SiO₂ | 137 | D | 24.5 |
| 5 | e | 36.2538 | 1.1884 | −4.8361 | 4.1560 | 35 | 83 | Al₂O₃ | 150 | E | 24.2 |
| 6 | f | 38.8891 | 2.0132 | −6.4738 | 4.1560 | 35 | 83 | Y₂O₃ | 148 | F | 24.5 |
| 7 | g | 40.3240 | 1.6358 | −6.0295 | 4.1560 | 35 | 83 | TiO₂ | 140 | G | 24.0 |
| 8 | h | 36.5625 | 2.1402 | −4.5210 | 4.1402 | 38 | 90 | ZrO₂ | 145 | H | 17.5 |
| 9 | i | 37.0251 | 2.1692 | −4.5782 | 4.1249 | 39 | 85 | ZrO₂ | 146 | I | 21.1 |
| Comparative | | | | | | | | | | | |
| Example: | | | | | | | | | | | |
| 1 | j | 36.3701 | 2.1309 | −4.4969 | 4.1570 | 353 | 910 | ZrO₂ | 50 | J | 14.6 |
| Example: | | | | | | | | | | | |
| 10 | a | 33.8959 | 2.5195 | −6.9554 | 4.1560 | 35 | 83 | ZrO₂ | 140 | K | 142.5 |
| 11 | b | 35.9237 | 2.4115 | −6.8733 | 4.1560 | 35 | 83 | Si₃N₄ | 150 | L | 142.2 |
| 12 | c | 39.7682 | 1.8995 | −6.1967 | 4.1560 | 35 | 83 | SiC | 145 | M | 142.2 |
| 13 | d | 36.6432 | 1.2012 | −4.8880 | 4.1560 | 35 | 83 | SiO₂ | 137 | N | 142.2 |
| 14 | e | 36.2538 | 1.1884 | −4.8361 | 4.1560 | 35 | 83 | Al₂O₃ | 150 | O | 141.8 |
| 15 | f | 38.8891 | 2.0132 | −6.4738 | 4.1560 | 35 | 83 | Y₂O₃ | 148 | P | 142.3 |
| 16 | g | 40.3240 | 1.6358 | −6.0295 | 4.1560 | 35 | 83 | TiO₂ | 140 | Q | 141.5 |
| 17 | h | 36.5625 | 2.1402 | −4.5210 | 4.1402 | 38 | 90 | ZrO₂ | 145 | R | 135.9 |
| 18 | i | 37.0251 | 2.1692 | −4.5782 | 4.1249 | 39 | 85 | ZrO₂ | 146 | S | 139.2 |
| Comparative | | | | | | | | | | | |
| Example: | | | | | | | | | | | |
| 2 | j | 36.3701 | 2.1309 | −4.4969 | 4.1570 | 353 | 910 | ZrO₂ | 50 | T | 122.2 |

*(Remarks) The numerical values in the column of “Solar radiation shielding performance (%) are, in Examples 1 to 9 and Comparative Example 1, values at VLT 65% and, in Examples 10 to 18 and Comparative Example 2, values at VLT 50%.

### POSSIBILITY OF INDUSTRIAL APPLICATION

As described above, the solar radiation shielding member according to the present invention has superior solar radiation shielding performance, and hence is suited for use in visible-light transmitting materials for which the solar radiation shielding performance is required, such as single-sheet glass, laminated glass, plastics or the like used in window materials for automobiles, buildings, offices, general houses and so forth, and in telephone booths, show windows, illuminating lamps, transparent cases and so forth.

1. A method of determining the suitability of a solar radiation shielding member comprising solar radiation shielding fine particles, said solar radiation shielding fine particles comprising fine hexaboride particles represented by XB₆ (wherein X is at least one selected from the group consisting of Y, La, Ce, Pr, Nd, Sm, Eu, Gd, Tb, Dy, Ho, Er, Tm, Yb, Lu, Zr, Ba, Sr and Ca), said fine hexaboride particles having an average primary-particle diameter of 400 nm or less and a lattice constant of from 4.100 to 4.160 and having a powder color in the L*a*b* color system of which L* is from 30 to 60, a* is from −5 to 10 and b* is from −10 to 2, wherein;
the solar radiation shielding member has a transmittance having a maximum value at a wavelength of from 400 nm to 700 nm and a minimum value at a wavelength of from 700 nm to 1,800 nm, and,
where the maximum value of the transmittance is represented by P, the minimum value thereof by B and the visible-light transmittance by VLT, any solar radiation shielding member whose solar radiation shielding performance satisfying the following mathematical expression (1) at 60%≦VLT≦80% is determined to be acceptable, but any solar radiation shielding member whose solar radiation shielding performance not satisfying the mathematical expression (1) is determined to be unacceptable; or any solar radiation shielding member whose solar radiation shielding performance satisfying the following mathematical expression (2) at 38%≦VLT≦55% is determined to be acceptable, but any solar radiation shielding member whose solar radiation shielding performance not satisfying the mathematical expression (2) is determined to be unacceptable:
P/B+0.2067×VLT≧17.5 (1)
P/B+2.4055×VLT≧133.6 (2).

2-9. (canceled)
